(19) United States
(12) Patent Application Publication
(10) Pub. No.: US 2024/0281070 A1
(43) Pub. Date: Aug. 22, 2024

(54) Simultaneous Controller and Touch Interactions

(71) Applicant: Meta Platforms Technologies, LLC, Menlo Park, CA (US)

(72) Inventors: Ali EMAMI, San Diego, CA (US); Aaron SELIG, Belmont, CA (US); Ahad Habib BASRAVI, Oakland, CA (US); James Michael-K O'DONNELL, Menlo Park, CA (US); Nathaniel LANE, Wrentham, MA (US); Todd HARRIS, Woodinville, WA (US)

(21) Appl. No.: 18/310,622

(22) Filed: May 2, 2023

Related U.S. Application Data
(60) Provisional application No. 63/485,414, filed on Feb. 16, 2023.

(51) Int. Cl. G06F 3/01; G06F 3/0346; G06V 40/20

(52) U.S. Cl. CPC G06F 3/017; G06F 3/0346; G06V 40/28

(57) ABSTRACT

An artificial reality (XR) system includes XR controllers and hand gestures and corresponding representation of the hand gestures in XR space. Example implementations allow a user to use controllers for distance interaction and interactions that require controller buttons, but also recognize when the user extends her finger and wants to manually touch things-using touch in conjunction with controllers. Thus, if the user has a controller in her hand and wants to touch a UI element, she can also use her finger. In particular, the system identifies the finger is not touching the controller (e.g., via capacitance sensors) and that a hand pose is present (e.g., finger extended—from camera), thereby processing hand input from the finger without the user having to put down the controller.

### CROSS-REFERENCE TO RELATED APPLICATIONS

This application claims priority to U.S. Provisional Patent Application No. 63/485,414 filed on Feb. 16, 2023 and titled “SIMULTANEOUS CONTROLLER AND TOUCH INTERACTIONS,” which is herein incorporated by reference in its entirety.

### TECHNICAL FIELD

The present disclosure is directed to artificial reality controllers and hand gestures and corresponding representation of the hand gestures in artificial reality space.

### BACKGROUND

Virtual reality (VR) environments can be provided by a variety of systems, such as projectors, head mounted displays, “cave” systems, etc. Users can interact with an artificial reality environment, such as by selecting objects, moving, rotating, resizing, actuating controls, changing colors or skins, defining interactions between virtual objects, setting virtual forces to act on virtual objects, or practically any other imaginable action. Various interaction modalities exist for these taking such actions in a VR environment. For example, some systems can employ one or more of gaze controls, hand-held hardware devices, gesture controls, wearable devices (e.g., wrist bands), voice controls, etc.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIGS. 5A and 5B illustrate two hand gestures in connection with a controller for some implementations of the present technology.

FIG. 6 illustrates an alternative avatar when the user's index finger is no longer contacting a button of a controller for some implementations of the present technology.

FIG. 7A illustrates a “pinch” gesture detected via the controller for some implementations of the present technology.

FIG. 7B illustrates a “poke/press” gesture detected via the controller for some implementations of the present technology.

FIG. 8A illustrates a “neutral” gesture detected via the controller for some implementations of the present technology.

FIG. 8B illustrates a “full-hand grab” gesture detected via the controller for some implementations of the present technology.

FIGS. 9-12 illustrate various different input states of the controller, and the corresponding visually rendered avatar for some implementations of the present technology.

FIGS. 13A and 13B illustrate, for some implementations of the present technology, a transition between the avatar showing both the controller and hand (FIG. 13A) and then, as the controller gets closer to the UI, the hand avatar without the controller (FIG. 13B).

FIG. 14 is a flow diagram illustrating a process used in some implementations for facilitating simultaneous controller and touch interactions by providing direct touch interaction with virtual objects while a user holds the controller.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to artificial reality (XR) controllers and hand gestures, and providing the ability to use touch interactions, via hand gestures, while also holding the XR controller.

Example implementations allow a user to use controllers for distance interaction and interactions that require controller buttons, but also recognize when the user extends her finger and wants to manually touch things-using touch in conjunction with controllers. Thus, if the user has a controller in her hand and wants to touch a user interface (UI) element, she can also use her finger. In particular, the system identifies the finger is not touching the controller (e.g., via capacitance sensors) and/or that a hand pose is present (e.g., a finger is extended as detected from a camera), thereby processing hand input from the finger without the user having to put down the controller.

Example implementations can further automatically switch between an avatar of a hand holding the controller to a hand only avatar without rendering the controller (i.e., direct interaction hand visualization) based on distance from the UI or a detection of a hand pose. The rendering of the hand only avatar without controller can vary depending on the sensed position of the user's hand on the controller.

Example implementations can further automatically switch between ray casting using the controller for UI input to a finger for UI input based on a distance between the controller and the UI.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Conventional systems allow interaction via controller, such as via an XR controller or a conventional mouse. However, for some interaction tasks, such as selecting an object, the user's hand/finger is more advantageous. In contrast, example implementation can improve computing and/or computer system by allowing a seamless transition between using a controller and using a hand for interacting with objects, thus optimizing the type of interaction (e.g., controller or hand) based on the environment and user interface scenario.

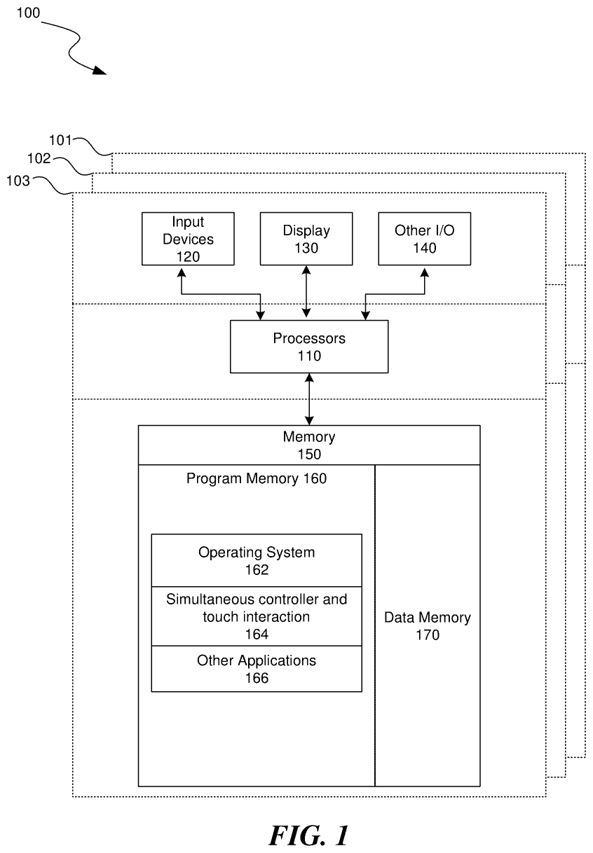

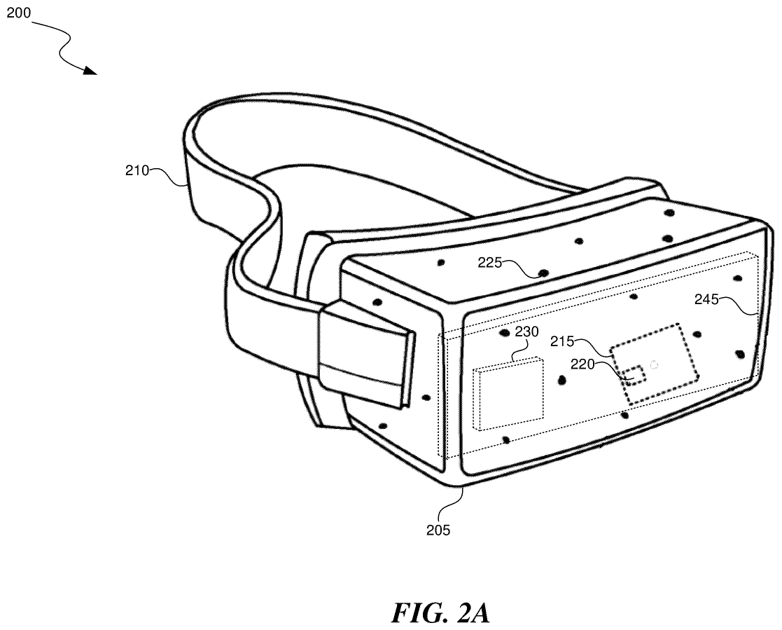

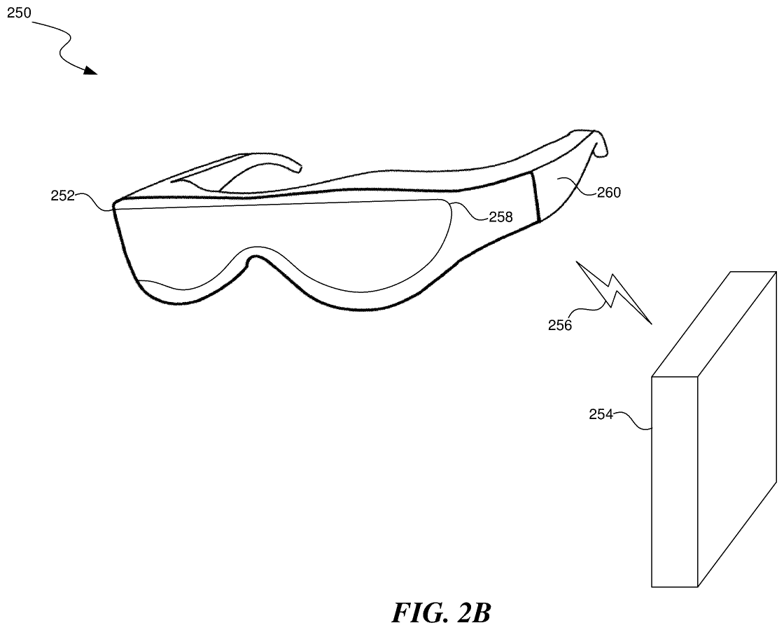

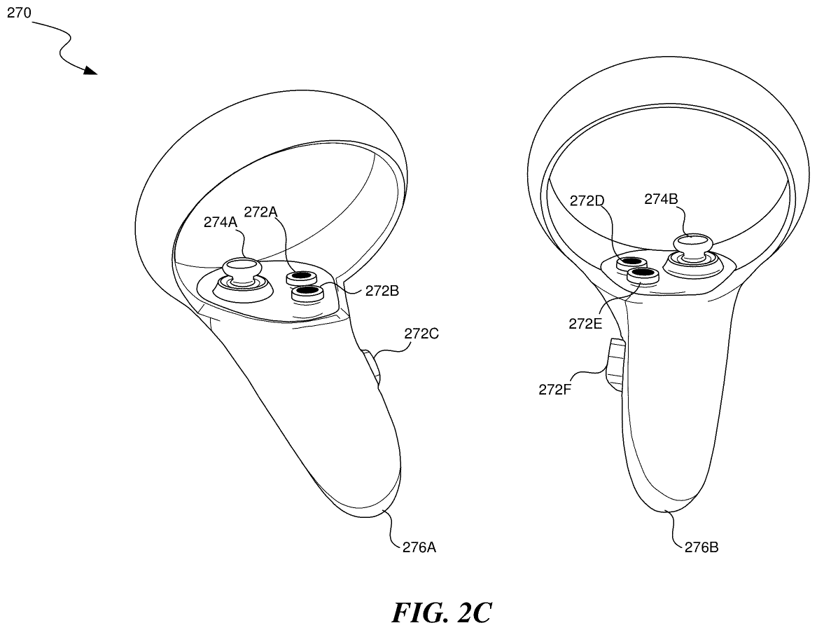

Several implementations are discussed below in more detail in reference to the figures. FIG. 1 is a block diagram illustrating an overview of devices on which some implementations of the disclosed technology can operate. The devices can comprise hardware components of a computing system 100 that provide simultaneous controller and touch interactions. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, simultaneous controller and touch interaction system 164, and other application programs 166. Memory 150 can also include data memory 170 that can include, e.g., data used to determine hand gestures, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons and/or 272A-F) joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

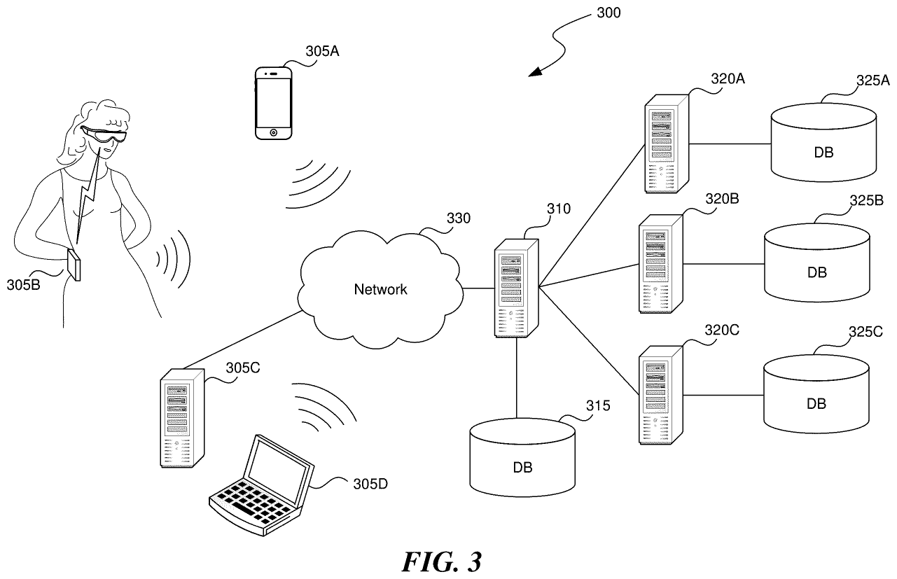

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

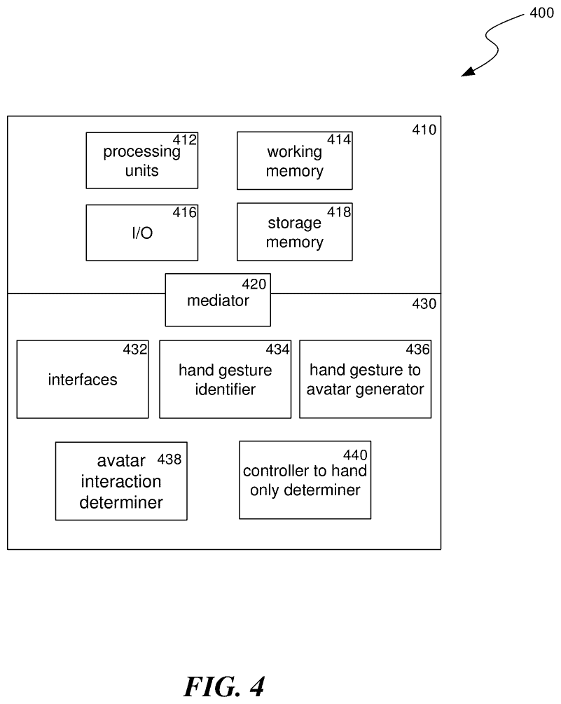

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for simultaneous controller and touch interactions. Specialized components 430 can include a hand gesture identifier 434, a hand gesture to avatar generator 436, an avatar interaction determiner 438, a controller to hand only determiner 440, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

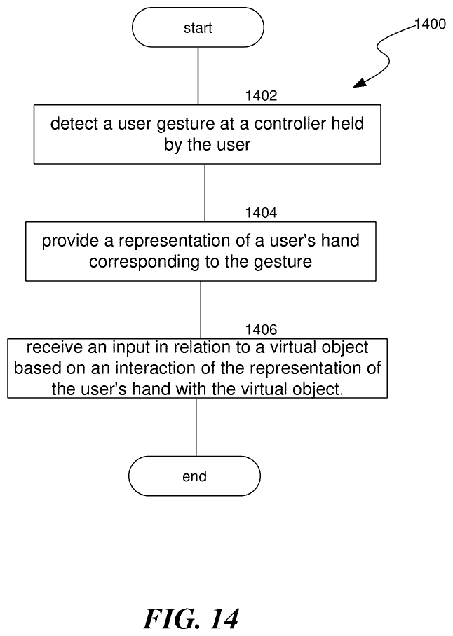

Hand gesture identifier 434 identifies hand gestures of the user. The hand gesture can be identified using sensors of controllers 270, using cameras of HMD 200 or 250, using cameras of controllers 270, identifying a rotation of controllers 270, or any combination. Additional details on identifying the hand gestures of the user are provided below with reference to block 1402 of FIG. 14.

Hand gesture to avatar generator 436 generates an avatar that includes the hand gesture corresponding to the identified hand gesture from hand gesture identifier 434. Additional details on generating the avatar from the identified hand gesture are provided below with reference to block 1404 of FIG. 14.

Avatar interaction determiner 438 processes an input based on an interaction of the representation of the user's hand with a virtual object. Additional details on processing the input are provided below with reference to block 1406 of FIG. 14.

Controller to hand only determiner 440 determines when an avatar that includes a controller should be converted to a hand only avatar (i.e., rendering the hand without rendering the controller), and vice versa, based on a threshold distance from the UI or a virtual object or an output of the hand gesture identifier 434. Additional details on determining when the avatar should no longer include a controller are provided below with reference to block 1406 of FIG. 14.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

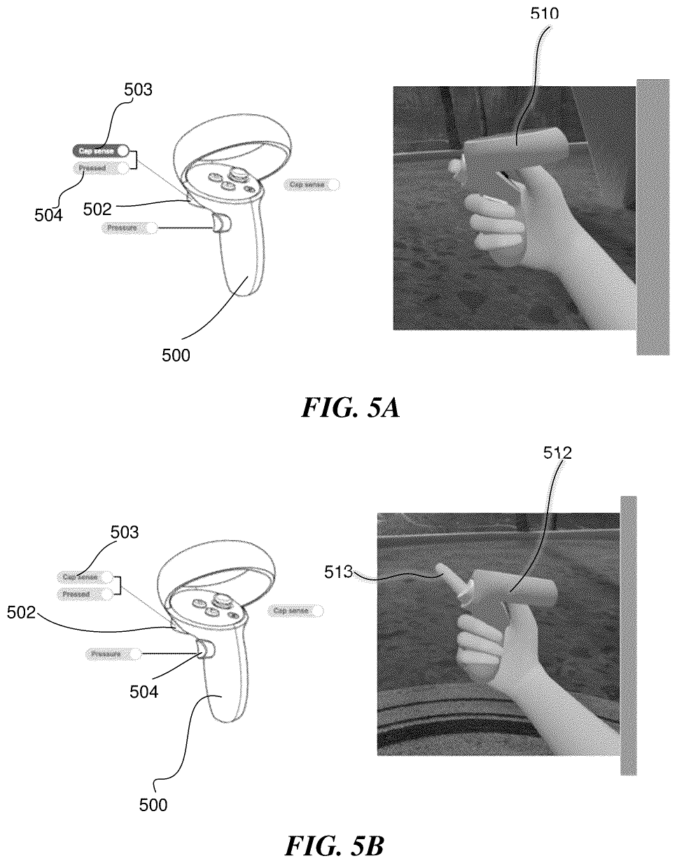

FIGS. 5A and 5B illustrate two hand gestures in connection with a controller for some implementations of the present technology. FIG. 5A illustrates a controller 500 (which can be implemented by one of controllers 270 of FIG. 2C) that is intended to be gripped by a user's hand. In general, the user's index finger will be contacting button 502 when controller 500 is fully gripped. A capacitive sensor or other means can determine that the user's index finger is contacting (or not contacting) button 502. In examples, the avatar representation on the UI when controller 500 is fully gripped and the user's index finger is contacting button 502 (as indicated at 503) is shown at 510.

FIG. 5B illustrates controller 500 that is gripped by the user where the user has extended their index finger with the intent of initiating a pointing gesture. The capacitive sensor in button 502 detects that the index finger is no longer contacting button 502. In examples, the avatar representation on the UI when the user's index finger is no longer contacting button 502 (as indicated at 503) is shown at 512. The avatar's index finger 513, corresponding to the user's actual index finger, which is assumed to be extended, or can be confirmed to be extended via a camera, can be used to select an object on the user interface using a natural pointing motion.

Any of the buttons, including button 504, or any other portions of controller 500 can implement capacitive sensors that generate a signal or “contact data” when the portion is contacted by the user's hand (e.g., by the user's finger, palm, etc.). The contact data can indicate that the corresponding portion is being touched, a button is being pressed (indicated as the presence of pressure at 504 using a pressure sensor, etc.), a joystick is being pushed, etc.

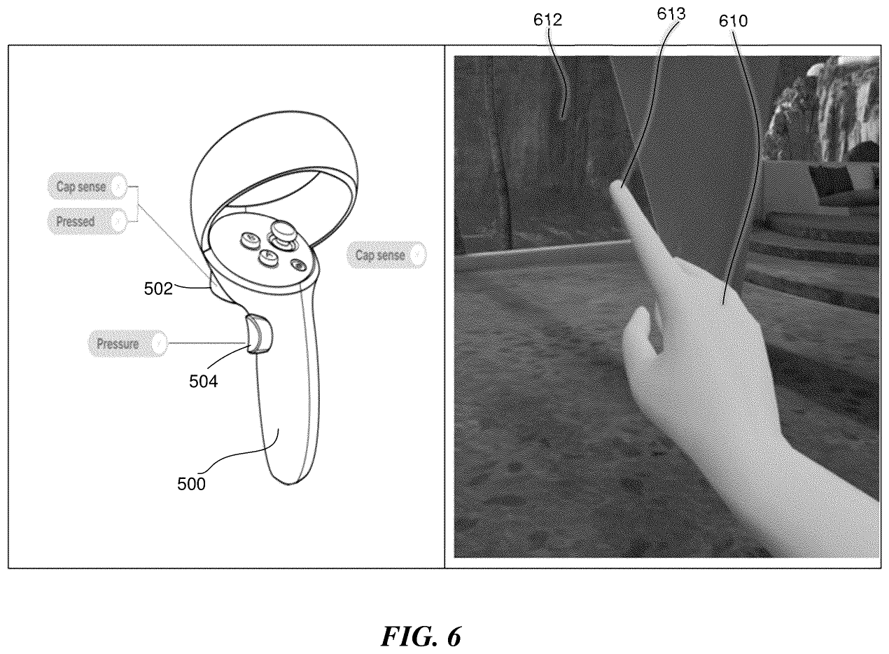

FIG. 6 illustrates an alternative avatar when the user's index finger is no longer contacting button 502 of controller 500 for some implementations of the present technology. In contrast to avatars 510 and 512 of FIGS. 5A and 5B, avatar 610 illustrates the user's hand without the controller the user is holding being rendered (referred to as a “hand only” avatar). Avatar 610 is rendered based on the gesture of the index finger being removed from the controller button and extended so that it can be used for pointing and selecting. Avatar 610 can be generated automatically in response to the user's finger ceasing contact with button 502, or may be transitioned to when a threshold distance from the controller to the user interface is reached. As shown, the avatar's index finger 613, which corresponds to the user's actual index finger, can be used to select any virtual object or other area on UI 612.

Avatar 601 can be rendered in response to controller 500 receiving and processing contact data, which is generated in response to a contact by the user on button 502 (or another button or portion of controller 500 in other example implementations). The contact data can be generated in response to a capacitive sensor in button 502 sensing (or not sensing) contact with button 502. The contact data can be in the form of a Boolean yes or no as to whether or not the user is contacting button 502, or a capacitance range, where once a threshold is surpassed, it is conclusively determined that the user is no longer contacting button 502 and avatar 610 is rendered. With the capacitance range, the rendering of avatar 610 can change depending on the level of the range. For example, in an interim period before the threshold is surpassed, avatar 610 may be rendered with index finger 613 being partially extended, but not fully extended.

In addition to the index pointing gesture or pose, which is illustrated in FIGS. 5 and 6, capacitive sensors or other means such as pressure sensors can generate contact data of the user's hands to detect other types of gestures or poses.

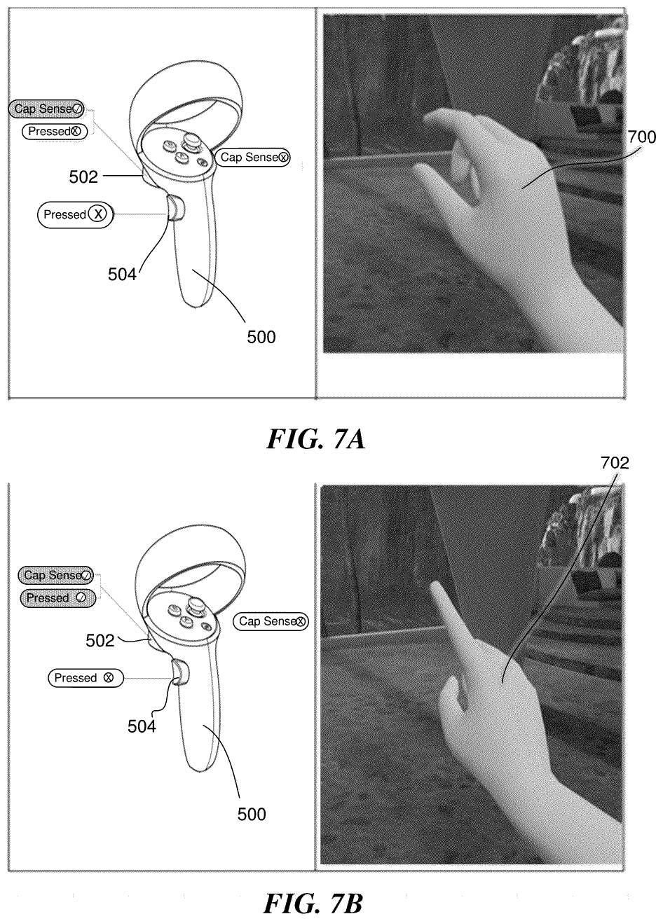

FIG. 7A illustrates a “pinch” gesture detected via controller 500 for some implementations of the present technology. For example, the pinch gesture can be shown when the virtual location of the controller is close to a location of a virtual interface. For the pinch gesture input state, contact on button 502 is sensed, without button 502 being pressed. A corresponding visually rendered avatar 700 is generated.

FIG. 7B illustrates a “poke/press” gesture detected via controller 500 for some implementations of the present technology. For the poke/press gesture input state, contact is sensed on button 502, and button 502 being pressed is sensed. A corresponding visually rendered avatar 702 is generated.

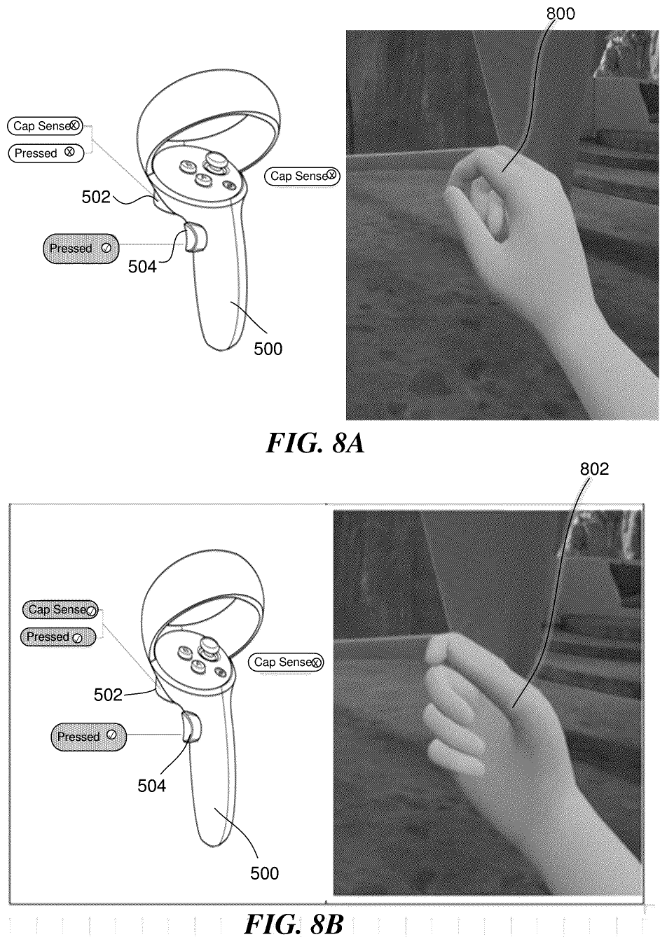

FIG. 8A illustrates a “neutral” gesture detected via controller 500 for some implementations of the present technology. For the neutral gesture input state, contact is sensed on button 502, and button 502 being pressed is sensed and button 504 being pressed is sensed. A corresponding visually rendered avatar 800 is generated.

FIG. 8B illustrates a “full-hand grab” gesture detected via controller 500 for some implementations of the present technology. For the full-hand grab gesture input state, contact is sensed on button 502, and button 502 being pressed is sensed and button 504 being pressed is sensed. A corresponding visually rendered avatar 802 is generated.

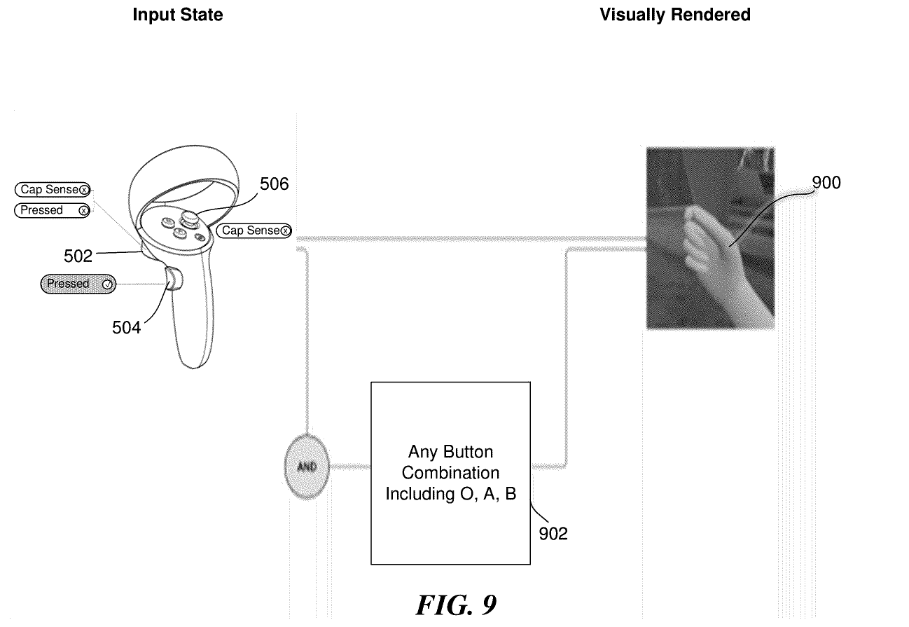

FIGS. 9-12 illustrate various different input states of the controller, and the corresponding visually rendered avatar for some implementations of the present technology. As shown in FIGS. 7-12, different input states may result in the same corresponding avatar, and the same input states may result in different corresponding avatars, depending on the type of state of the application, or other factors.

As illustrated in FIG. 9, for the input state, button 502 is not touched or pressed, button 504 is pressed, joystick 506 is not touched, and any other button combination, e.g., the O, A, or B buttons next to joystick 506, can be pressed at 902. In response, corresponding visually rendered avatar 900 is generated.

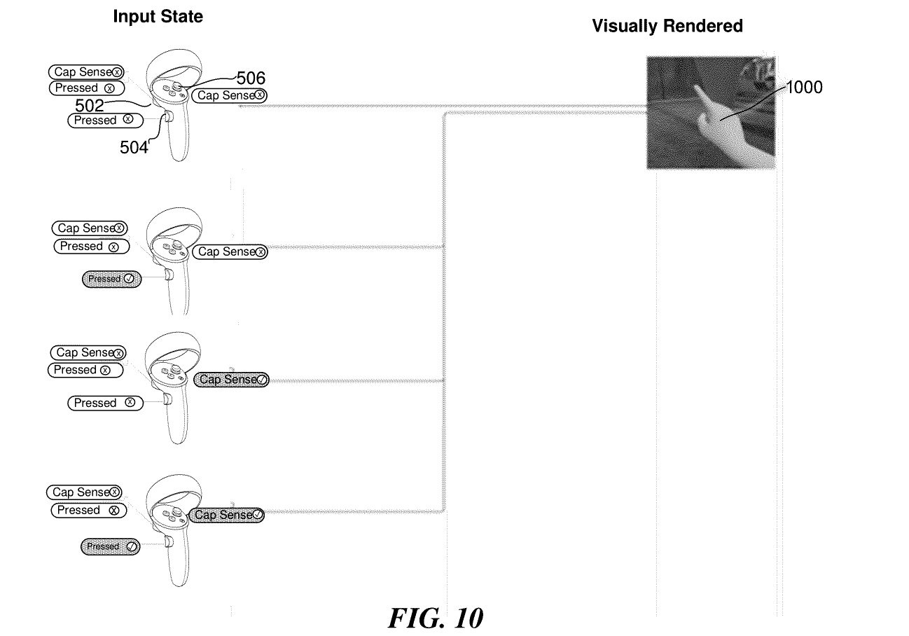

As illustrated in FIG. 10, for the input state, button 502 is not touched or pressed, button 504 can be pressed or not pressed and joystick 506 can be touched or not touched. In response, corresponding visually rendered avatar 1000 is generated.

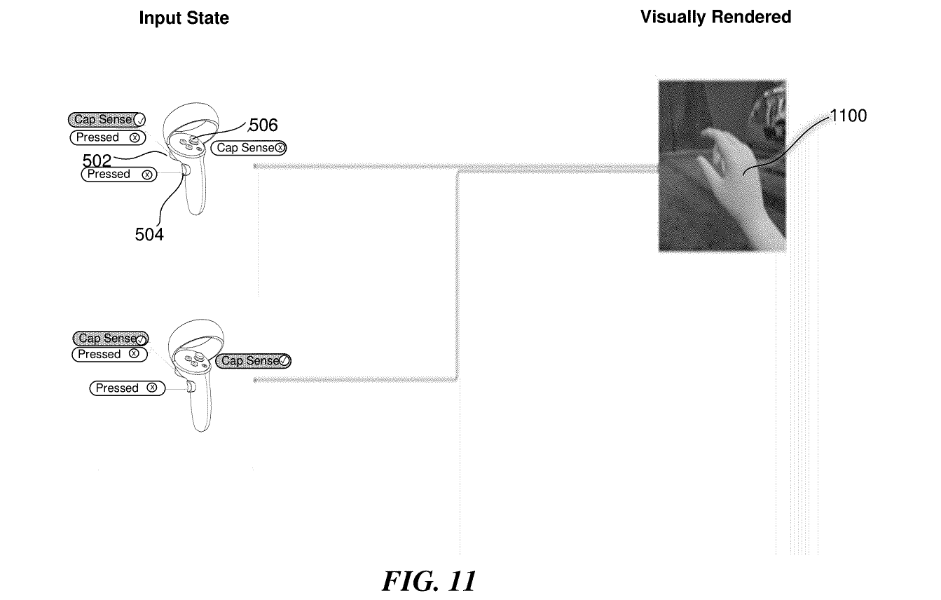

As illustrated in FIG. 11, for the input state, button 502 is touched and not pressed, button 504 is not pressed and joystick 506 can be touched or not touched. In response, corresponding visually rendered avatar 1100 is generated.

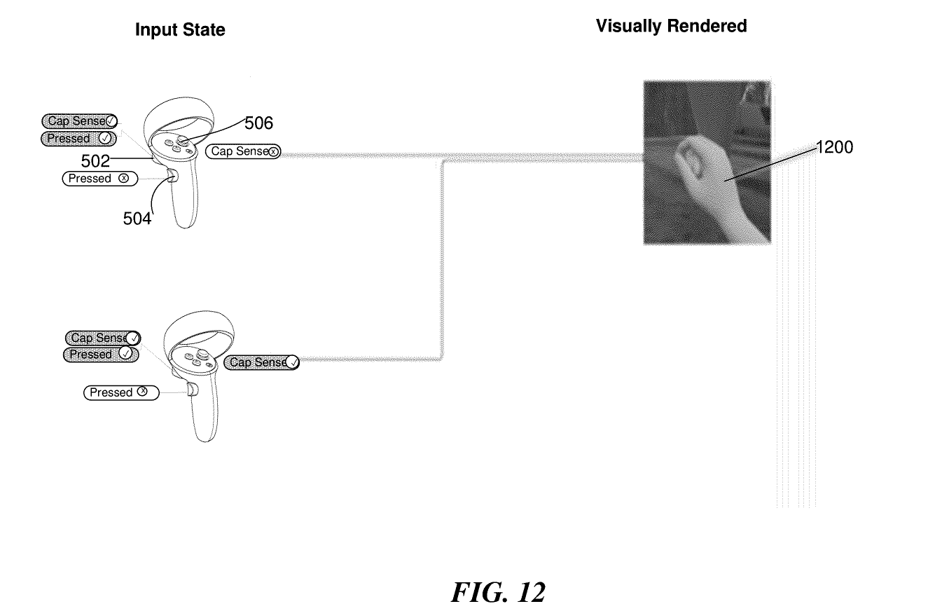

As illustrated in FIG. 12, for the input state, button 502 is touched and pressed, button 504 is not pressed and joystick 506 can be touched or not touched. In response, corresponding visually rendered avatar 1200 is generated.

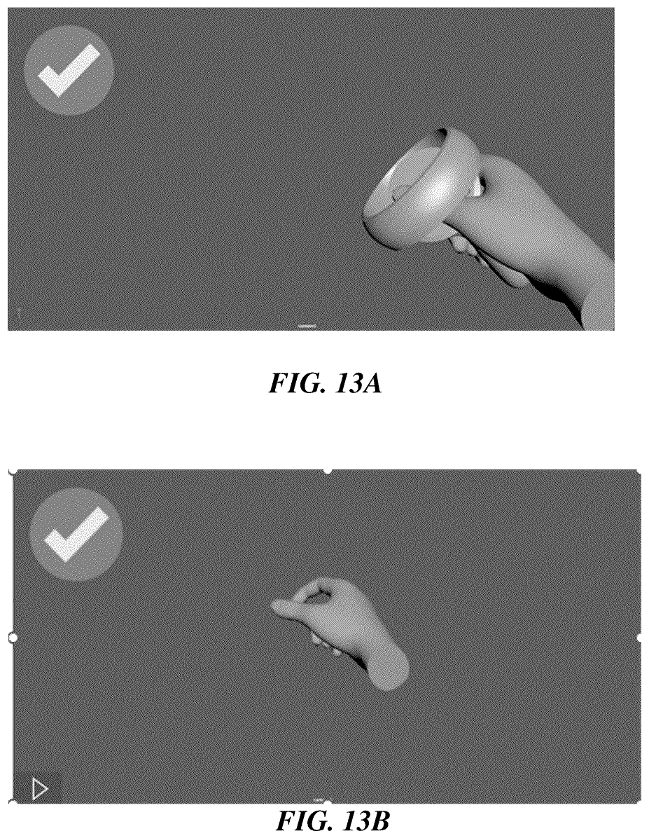

FIGS. 13A and 13B illustrate, for some implementations of the present technology, a transition between the avatar showing both the controller and hand (FIG. 13A) and then, as the controller gets closer to a target object on the UI, the hand only avatar without the controller (FIG. 13B). The threshold distance from the target object to the user where the transition occurs can be predefined (e.g., 2 or 3 feet from the user) or variable depending on the content of the UI or other factors. In some cases, the threshold distance is determined based on the arm span (e.g., a percentage value of the user's arm length) of the user, such as whether the target object is within arm's reach of the user. In some implementations, the distance between the controller and the target object is calculated by a distance between the coordinate of the controller in virtual space and the coordinate of the target object in virtual space.

FIG. 14 is a flow diagram illustrating a process 1400 used in some implementations for facilitating the simultaneous controller and touch interactions by providing direct touch interaction with virtual objects while a user holds the controller. In some implementations, process 1400 can be performed “just in time,” e.g., as a response to the UI displaying selectable objects.

At block 1402, process 1400 detects, at a controller, a user gesture while the user holds the controller. The detection can include processing contact data on one or more locations on the controller, where the contact data can be generated by one or more capacitive sensors. The locations can be any portion of the controller, including buttons, joysticks, switch, grip, etc. In one example, the contact data is generated in response to a transition of contact of a finger of the user on a button to the finger not contacting the first button, such as when extending an index finger as shown in FIGS. 5A and 5B.

In other example implementations, detecting the user gesture or hand “posture” at block 1402 includes, in combination with the contact data or by itself, collecting visual data of the user gesture using a camera, that may be included in the headset and/or the controller, and determining, using one or more machine learning models such as a classifier, whether the user is contacting one or more locations on the controller.

A hand posture refers to a hand location and/or pose. For example, a hand posture can comprise one or both of where the hand is in an artificial reality environment and/or the shape the hand is making. Certain hand postures can be previously identified in training data as “gestures.” For example, the training data can include images or videos of a pinch gesture or a pointing gesture from multiple angles. The classifier can be trained on the training data to output a hand pose classification based on input hand postures. The processes described herein can monitor hand postures in different manners. In some cases, hand postures can be identified using input from external facing cameras that capture depictions of user hands. In other cases, hand postures can be based on input from a wearable device such as a glove or wristband that tracks aspects of the user's hands. In some implementations, input can be interpreted as postures mapped as certain gestures by applying the input to a machine learning model trained to identify hand postures and/or gestures based on such input. In some implementations, heuristics or rules can be used to analyze the input to identify hand postures and/or gestures.

In other example implementations, detecting the user gesture at block 1202 includes detecting a rotation of the controller via, for example, a gyroscope. The rotation of the controller, using one or more classifiers, can establish a user gesture.

The detected gestures in block 1402 can include a neutral gesture, a pointing gesture, a pinch gesture, a swipe gesture, a full hand grip gesture, etc.

At block 1404, process 1400 provides, in an artificial reality environment, a representation of a user's hand corresponding to the gesture. The representation can also include a representation of the controller, such as shown in FIG. 5B, or be a hands only representation, such as shown in FIG. 6. At least one gesture, in response to the index finger being removed from a button and pointing forward, can enhance the ability to select an object in the UI.

In example implementations, at block 1404, process 1400 determines a distance between the representation of the user's hand and the virtual object when providing the representation of the user's hand corresponding to the gesture. Process 1400, in response to determining the distance is greater than a threshold distance, renders the representation of the user's hand in the artificial reality environment as holding a virtual controller. Further, process 1400, in response to determining the distance is less than the threshold distance, renders the representation of the user's hand without the virtual controller.

At block 1406, process 1400 receives an input in relation to a virtual object based on an interaction of the representation of the user's hand with the virtual object. In one example invention, the representation of the user's index finger (or any other finger) is used to interact with the virtual object via a pointing movement. The interaction can be a selection of the virtual object.

Example implementations allow the user to interact with the UI that is very close (via pointing) while still holding the controller. Example inventions can also fade out the controller in the representation, so the user only sees a hand, without rendering the controller, when the index finger is used for pointing, as shown in FIG. 6.

Example implementations further enable a preferred input method (e.g., controller or hand) depending on the context. It provides seamless switching between controller and hand. Example implementations can utilize digital tracking of the controller, which in some examples works better and more accurately than the tracking of a hand.

Example implementations can include haptics in the controller to enable feedback to the user when using a finger to touch (i.e., assisted touch) as opposed to using pure hands (i.e., no controller) for interaction. For example, when the rendered finger “touches” or otherwise interacts with an object on a UI, an actuator located on a portion of the controller, such as the grip, will generate vibrations to confirm the touch to the user.

Example implementations can change hand visualization (e.g., of the avatar) to reflect a hand gesture to show an intended action, which can be different than the actual user's hand position. Example implementations can infer gestures based on mappings of inputs/sensed grips on the controller to expected corresponding gestures.

Example implementations can also use cameras and vision to determine a hand gesture when gripping the controller in place of or in addition to the touch sensing. In some implementations, this can be done by receiving input from a camera that can be located on the controller or on the head mounted device, and that captures images of the user's hand and determines, based on the images, a posture such as a 3D model of the hand, a skeletal representation of the hand, relative coordinates or distances for specified points on a hand (e.g., various joints and fingertips), etc. In some implementations, hand postures can be monitored based on other input in addition to cameras and/or sensing touch on the controller, such as from sensors in a wearable glove or bracelet, sonar or ultrasound sensors, etc. This multimodal tracking is helpful, for example, when switching between using a controller and using pure hands for interaction.

Example implementations can also use a stylus as a controller with capacitive sensing to determine which portion of the stylus the user is touching or any other type of physical input device (e.g., keyboard, mouse, etc.).

Example implementations can transition visualizations from when the avatar is a hand holding a controller to a hand only based on distance of the hand/controller from UI elements. The transition to hand only can occur when the distance is reduced below a threshold. Example implementations can have a mid-transition to “ghost” opaque controller before transitioning to hand only. Example implementations can show the controller with a finger off before fading away the controller to the hand only representation.

Example implementations can also detect controller rotation using gyroscopes of the controller or computer vision and use the rotation as another trigger for determining direct hand input.

Capacitive sensors in example implementations can be on one or more buttons of the controller and can also be on the grip. Example implementations can also track how far finger is lifted off of a button (e.g., using a camera on the HMD or controller).

Example implementations can detect hand position or infer gestures based on buttons being touched or augmented or replaced by a computer vision system. Any sensors can be used to infer user gestures, such as based on motions as determined by an IMU.

In example implementations, when close to the UI and/or the user's finger is lifted off the controller, the system can use finger touching for direct interaction with the UI. When further from the UI and/or if the user's finger is not lifted off the controller, example implementations can use ray casting from the controller for input. If the user's hand is, for example, >15 cm from the UI that their hand is aiming towards the UI, example implementations can show a line or ray from the user's hand to the UI. When a user's hand is near a UI, she can directly interact with the UI using her hand. The user can pinch to make a selection like she normally would with her hand.

In some implementations, as long as the user is interacting with a ray cast from a controller, example implementations may not switch to hand only mode until the hand is within, for example, 8 cm of the UI to avoid constant switching. Example implementations can also look at heuristics such as the trajectory of the hand and if it is moving closer to the UI. The distance used can be far enough where the system does not accidentally show the user a ray when not intended but also close enough to allow the user to hold their hand in a restful state to interact.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for providing direct touch interaction with virtual objects while a user holds a controller, the method comprising:
detecting a user gesture while the user holds the controller;
providing, in an artificial reality environment, a representation of a user's hand corresponding to the gesture; and
receiving an input, while the user holds the controller, in relation to a virtual object based on an interaction of the representation of the user's hand with the virtual object.

2. The method of claim 1, wherein detecting the user gesture comprises processing contact data on one or more locations on the controller.

3. The method of claim 2, wherein the one more locations comprise a first button of the controller.

4. The method of claim 3, wherein the contact data is generated in response to a transition of contact of a first finger of the user on the first button to the first finger not contacting the first button.

5. The method of claim 4, wherein the first finger comprises an index finger, and the gesture comprises a pointing gesture.

6. The method of claim 5, wherein the input comprises a selection of the virtual object.

7. The method of claim 2, wherein the controller comprises at least one capacitive sensor that generates the contact data used for determining whether the user is contacting one or more locations on the controller.

8. The method of claim 2, wherein detecting the user gesture comprises:
collecting visual data of the user gesture using a camera; and
determining, using one or more classifiers, whether the user is contacting one or more locations on the controller.

9. The method of claim 1, wherein providing, in the artificial reality environment, the representation of a user's hand corresponding to the gesture includes providing a representation of the controller.

10. The method of claim 1, wherein providing, in the artificial reality environment, the representation of a user's hand corresponding to the gesture comprises:
determining a distance between the representation of the user's hand and the virtual object;
in response to determining the distance is greater than a threshold distance, rendering the representation of the user's hand in the artificial reality environment as holding a virtual controller; and
in response to determining the distance is less than the threshold distance, rendering the representation of the user's hand without the virtual controller.

11. The method of claim 1, wherein the gesture comprises a neutral, pointing, pinch, swipe or full hand grip.

12. The method of claim 1, wherein the detecting the user gesture comprises detecting a rotation of the controller.

13. A computer-readable storage medium storing instructions that, when executed by a computing system, cause the computing system to perform a process for providing direct touch interaction with virtual objects while a user holds a controller, the process comprising:
detecting a user gesture while the user holds the controller;
providing, in an artificial reality environment, a representation of a user's hand corresponding to the gesture; and
receiving an input, while the user holds the controller, in relation to a virtual object based on an interaction of the representation of the user's hand with the virtual object.

14. The computer-readable storage medium of claim 13, wherein detecting the user gesture comprises processing contact data on one or more locations on the controller.

15. The computer-readable storage medium of claim 14, wherein the one more locations comprise a first button of the controller.

16. The computer-readable storage medium of claim 15, wherein the contact data is generated in response to a transition of contact of a first finger of the user on the first button to the first finger not contacting the first button.

17. The computer-readable storage medium of claim 16, wherein the first finger comprises an index finger, and the gesture comprises a pointing gesture.

18. The computer-readable storage medium of claim 17, wherein the input comprises a selection of the virtual object.

19. The computer-readable storage medium of claim 14, wherein the controller comprises at least one capacitive sensor that generates the contact data used for determining whether the user is contacting one or more locations on the controller.

20. A computing system for providing direct touch interaction with virtual objects while a user holds a controller, the computing system comprising:
one or more processors; and
one or more memories storing instructions that, when executed by the one or more processors, cause the computing system to perform a process comprising:
detecting a user gesture while the user holds the controller;
providing, in an artificial reality environment, a representation of a user's hand corresponding to the gesture; and
receiving an input, while the user holds the controller, in relation to a virtual object based on an interaction of the representation of the user's hand with the virtual object.
